(19) United States
(12) Patent Application Publication
(10) Pub. No.: US 2025/0360824 A1
(43) Pub. Date: Nov. 27, 2025

(54) STATIONARY VEHICLE BATTERY CHARGER CABLE MANAGEMENT SYSTEM

(71) Applicant: BorgWarner Inc., Auburn Hills, MI (US)

(72) Inventors: Lorenzo Caprotti, Vimercate (IT); Andrea Egidio Arienti, Mandello del Lario (IT)

(21) Appl. No.: 18/673,372

(22) Filed: May 24, 2024

(51) Int. Cl. B60L 53/35; B60L 53/18; H02G 11/02

(52) U.S. Cl. CPC B60L 53/35; B60L 53/18; H02G 11/02

(57) ABSTRACT

A charging cable management assembly configured to couple to a stationary vehicle battery charger, including an elongated frame configured to be coupled to the stationary vehicle battery charger; a movable support arm, coupled to the elongated frame, movable relative to the stationary vehicle battery charger and a battery electric vehicle (BEV) between a stowed and a deployed position relative; and a cable reel, attached to the movable support arm, deploying a retractable tether, configured to couple to a charging cable of the stationary vehicle battery charger, that assists a vehicle user moving the charging cable into electrical engagement with the BEV.

### TECHNICAL FIELD

The present application relates to battery electric vehicles (BEVs) and, more particularly, to stationary vehicle battery chargers that provide charge to the vehicle batteries carried by the BEVs.

### BACKGROUND

Sales of battery electric vehicles (BEVs) are increasing each year and a larger percentage of roadgoing BEVs can benefit from stationary charging. With the increase in BEV sales, businesses and governmental agencies will increase the availability of stationary vehicle battery chargers to offer charging for the batteries carried by the BEVs. As drivers transition from fuel pumps for fueling internal combustion engine (ICE) powered vehicles to stationary vehicle battery chargers, the ease with which the BEVs can be recharged will be noticed. It would be helpful to increase the ease with which drivers can charge their BEVs with the stationary vehicle battery charger.

### SUMMARY

In one implementation, a charging cable management assembly configured to couple to a stationary vehicle battery charger, including an elongated frame configured to be coupled to the stationary vehicle battery charger; a movable support arm, coupled to the elongated frame, movable relative to the stationary vehicle battery charger and a battery electric vehicle (BEV) between a stowed and a deployed position relative; and a cable reel, attached to the movable support arm, deploying a retractable tether, configured to couple to a charging cable of the stationary vehicle battery charger, that assists a vehicle user moving the charging cable into electrical engagement with the BEV.

In another implementation, a charging cable management assembly configured to couple to a stationary vehicle battery charger, including an elongated frame configured to be coupled to the stationary vehicle battery charger; a movable support arm, connected to the elongated frame via a pivot, pivotable relative to the stationary vehicle battery charger and a battery electric vehicle (BEV) between a stowed and a deployed position; and a cable reel, attached to the movable support arm, deploying a retractable tether, configured to couple to a charging cable of the stationary vehicle battery charger, that assists a vehicle user moving the charging cable into electrical engagement with the BEV.

In yet another implementation, a charging cable management assembly configured to couple to a stationary vehicle battery charger, including an elongated frame configured to be coupled to the stationary vehicle battery charger; a first movable support arm, coupled to the elongated frame, movable relative to the stationary vehicle battery charger and a battery electric vehicle (BEV) between a stowed and a deployed position; a first cable reel, attached to the first movable support arm, deploying a retractable tether, configured to couple to a charging cable of the stationary vehicle battery charger, that assists a vehicle user moving the charging cable into electrical engagement with the BEV; a second movable support arm, coupled to the elongated frame, movable relative to the stationary vehicle battery charger and the BEV between the stowed and the deployed position; and a second cable reel, attached to the second movable support arm, deploying another retractable tether, configured to couple to an additional charging cable of the stationary vehicle battery charger, that assists the vehicle user moving the additional charging cable into electrical engagement with the BEV.

### BRIEF DESCRIPTION OF THE DRAWINGS

FIG. 1 is a block diagram depicting an implementation of an electrical system including a stationary vehicle battery charger;

FIG. 2 is a perspective view depicting an implementation of a stationary vehicle battery charger including a charging cable management assembly;

FIG. 3 is a perspective view depicting an implementation of a charging cable management assembly;

FIG. 4 is a cross-sectional view depicting an implementation of a portion of a charging cable management assembly;

FIG. 5 is a perspective view depicting another implementation of a charging cable management assembly;

FIG. 6 is a cross-sectional view depicting an implementation of a charging cable management assembly; and

FIG. 7 is a perspective view depicting an implementation of a charging cable management assembly.

### DETAILED DESCRIPTION

A stationary vehicle battery charger can include a charging cable management assembly that eases the manual coupling/uncoupling of a charging cable attached to the stationary vehicle battery charger with either a passenger BEV or commercial BEV. The charging cable management assembly includes a movable arm, mounted to the stationary vehicle battery charger, that extends both toward and away from a vehicle. The arm includes a cable retractor, such as a reel, coupled to the movable arm, having a retractable tether that attaches to a point along the length of the charging cable. The movable arm and the retractable tether can extend away from the stationary vehicle battery charger and toward the BEV to help carry the weight of the charging cable as the driver or vehicle user moves the charging cable into a position so that it couples with the BEV and then pulls the charging cable towards the stationary vehicle battery charger when the vehicle owner returns the charging cable to its stored position, all while keeping the charging cable off the ground.

The combination of a moving arm along with the cable retractor and retractable tether may facilitate using longer cables (>5 meters) at the stationary vehicle battery charger such that it can service both commercial vehicles (buses and trucks), as well as passenger vehicles, in a way that the user can easily move the charging cable and prevent the charging cable from dragging across the ground, which would increase the effort needed by the vehicle user to move the charging cable. The moving arm with the cable retractor can also help avoid a risk of a user tripping on the cable or of environmental contamination, such as from snow or road dirt.

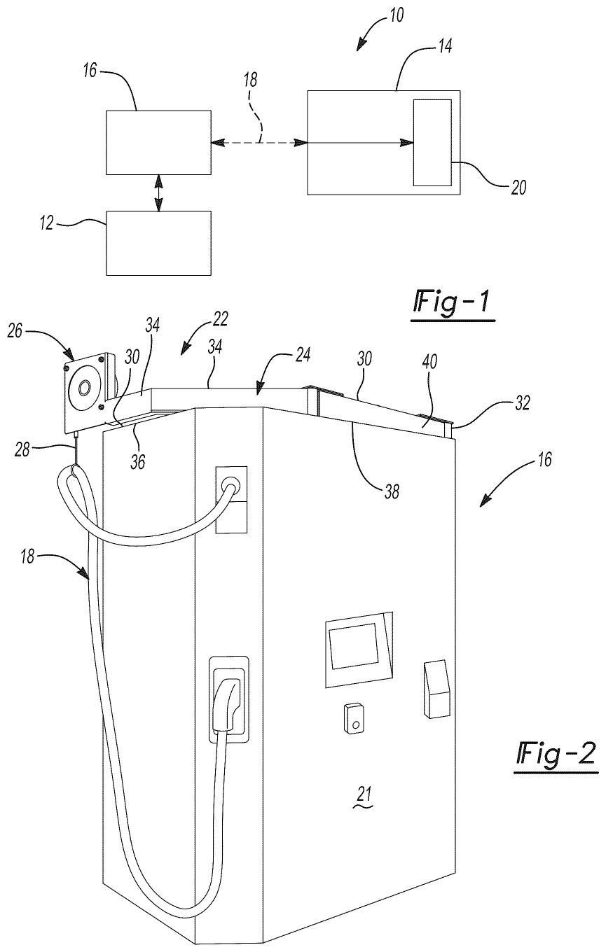

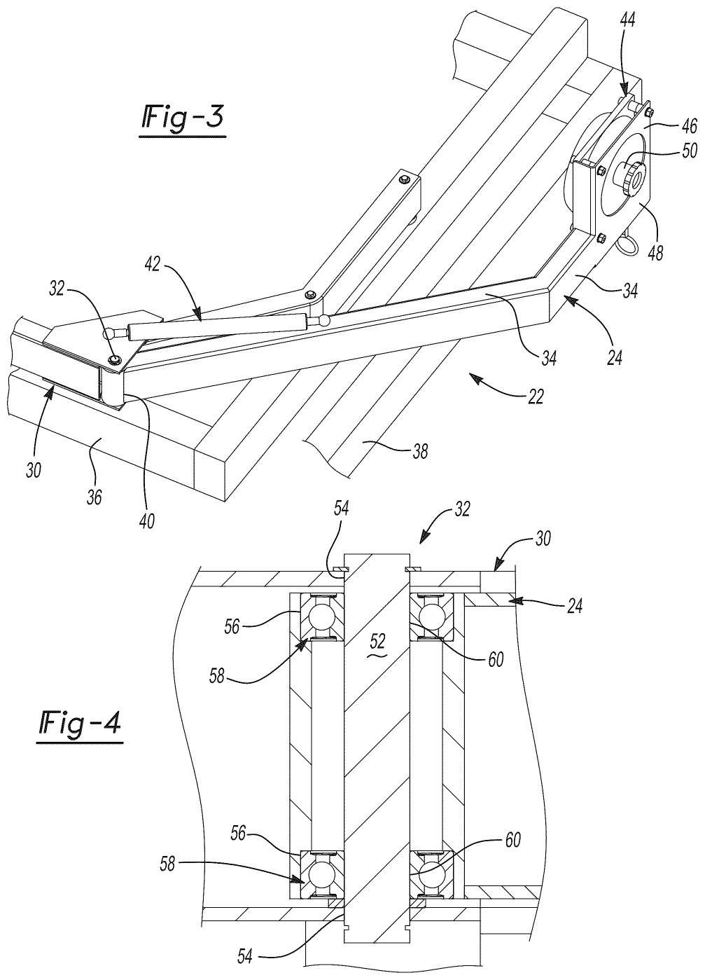

Turning to FIG. 1, an implementation of an electrical system 10 is shown including an electrical grid 12 and a battery electric vehicle (BEV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase 50-60 Hz. However, this voltage range can be different.

A stationary vehicle battery charger 16 can receive AC electrical power from the grid 12, rectify the AC electrical power into DC electrical power, and provide the DC electrical power to the BEV 14. The Stationary vehicle battery charger 16 can be geographically fixed, such as a charging station located in a vehicle garage, a bus/truck depot, or in a vehicle parking lot. The stationary vehicle battery charger 16 can include an input terminal that receives the AC electrical power from the grid 12 and communicates the AC electrical power to a BEV battery 20 directly, bypassing an on-board vehicle battery charger included on the BEV 14. A charging cable 18 can use a charging plug to detachably connect with an electrical receptacle on the BEV 14 and electrically link the stationary vehicle battery charger 16 with the BEV 14 so that DC electrical power can be communicated between the stationary vehicle battery charger 16 and the BEV battery 20. The stationary vehicle battery charger 16 can include a plurality of charging cables 18 to charge a plurality of BEVs 14 at the same time. The stationary vehicle battery charger 16 can receive 480 VAC from the grid 12 and have a power rating of 60-960 kW provided to the BEV 14. This configuration may be referred to as DC fast charging or Level 3 EV charging. However, the stationary vehicle battery charger 16 can be implemented using different standards.

The term “battery electric vehicle” or “BEV” can refer to vehicles that are propelled, either wholly or partially, by electric motors. BEV can refer to electric vehicles, plug-in electric vehicles, hybrid-electric vehicles, and battery-powered vehicles. It should be viewed as encompassing passenger vehicles, such as automobiles and motorcycles, as well as commercial vehicles, such as busses. The electrical components used to rectify the AC electrical power into DC electrical power can be enclosed within a housing 21 that provides a weather-resistant enclosure as well as sufficient support for the charging cable management assembly to suspend the charging cable off of the ground.

The BEV battery 20 can supply DC electrical power controlled by power electronics to the electric motors that propel the BEV 14. The BEV battery 20 or batteries are rechargeable and can include lead-acid batteries, nickel cadmium (NiCd), nickel metal hydride, lithium-ion, and lithium polymer batteries, to provide a few examples. A typical range of vehicle battery voltages can range from 100 to 1000V of DC electrical power (VDC). A control system, implemented as computer-readable instructions executable by a microprocessor, can be stored in non-volatile memory and called on to control functionality of the stationary vehicle battery charger 16 such that the microprocessor includes computer-readable instructions that execute a control scheme for controlling the switches included in the power modules, the primary group of switches, and the secondary group of switches. The microprocessor can include a plurality of control outputs linked to the gate inputs of the switches to selectively render the switches conductive. This will be discussed in more detail below.

Turning to FIGS. 2 & 3, an implementation of a charging cable management assembly is shown attached to the stationary vehicle battery charger 16. In this implementation, the charging cable management assembly 22 can include both a movable support arm 24 and a cable reel 26 attached to the pivotable arm 24. The cable reel 26 can deploy a retractable tether 28 that is coupled to the charging cable 18 at some point along its length. The charging cable management assembly 22 can include an elongated frame 30 for attaching the assembly 22 to the stationary vehicle battery charger 16. A pivot 32 can pivotably couple the movable support arm 24 with the elongated frame 30 permitting the movable support arm 24 to swing out and away from the stationary vehicle battery charger 16 from a stowed position to a deployed position. The size and shape of the charging cable management assembly 22 can be chosen so that when the movable support arm 24 is in a stowed or retracted position, the charging cable 18 is positioned away from the BEV 14 and substantially within a footprint occupied by the stationary vehicle battery charger 16. In this implementation, the movable support arm 24 can be formed in a plurality of sections 34 each joined at an angle.

FIGS. 2 & 3 depict two sections 34, one of which extends along a side 36 of the housing 21 and another section 34 that extends across the top of the housing 21 toward a front 38 of the housing 21. The elongated frame 30 can be coupled to the stationary vehicle battery charger 16 through the housing 21. In one implementation, the elongated frame 30 can be formed from extruded steel, but many other materials and methods of forming those materials are possible.

The movable support arm 24 can include the pivot 32 at a proximate end 40 and have a shape similar to the elongated frame 30. The movable support arm 24 can include sections that are joined together, such as by welding, and are positioned at an angle relative to each other. The movable support arm 24 can extend from the pivot 32 across the top of the housing 21 and beyond the front side of the housing 21. In this implementation, the movable support arm 24 is a pivotable support arm moving about the pivot 32. However, other implementations are possible in which the movable support arms moves using a different mechanism, such as a telescoping arm. A powered shaft 42 can attach to both the movable support arm 24 and the elongated frame 30 movably connecting these elements. The powered shaft 42 can be implemented as a gas piston, a spring, or other connector that delivers mechanical force to move the movable support arm 24 relative to the elongated frame 30 in a way that eases the amount of force needed from a vehicle user to move these elements and can help return the arm 24 to a retracted position. A distal end 44 of the movable support arm 24 can include an attachment 46 for the cable reel 26. The attachment 46 can be implemented in a variety of ways. For example, a planar surface 48 can be formed at the distal end 44 of the movable support arm 24 having one or more apertures for receiving bolts or other types of mechanical fasteners. In another implementation, a U-shaped loop can be threaded at each end, slide through apertures in the movable support arm 24, and attach to the movable support arm 24 using threaded nuts. The cable reel 26 hang from the attachment.

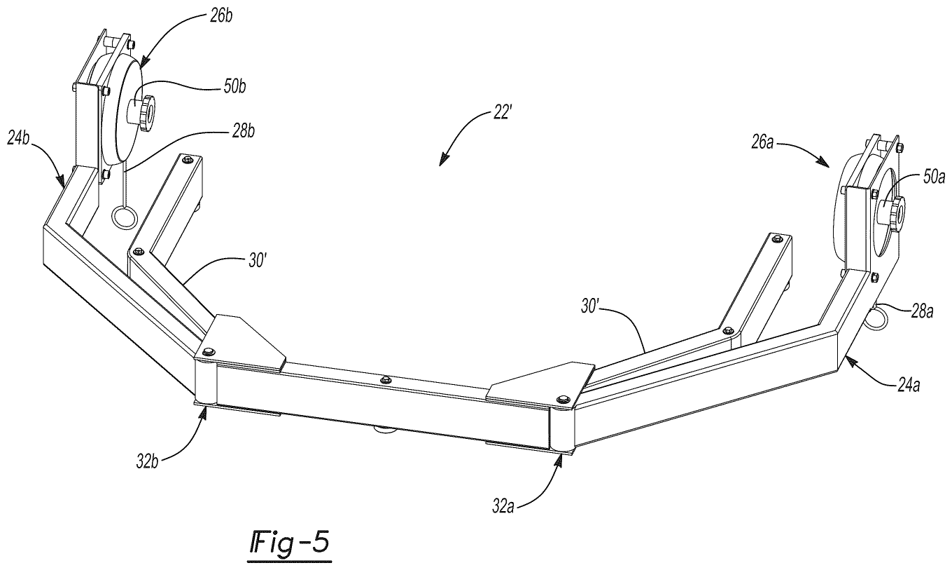

The cable reel 26 can include a spool 50 (shown in FIG. 5) that winds and feeds out the retractable tether 28 coupled to the charging cable 18. The spool 50 can rotate about an axle and include a spring that provides rotational assistance to rotate the spool 50 and forcibly wind the retractable tether 28 around the spool 50. The spool 50 can also include a clutch that permits the retractable tether 28 to unwind the retractable tether 28 from the spool 50 feeding out the tether 28 as the vehicle user brings the charging cable 18 into engagement with the BEV 14. The cable reel 26 can include a locking feature to decrease user pull force once the charging cable 18 is connected to the BEV 14. The retractable tether 28 can be implemented using a twisted or braided metal wire or it could be implemented using a cord made of synthetic material, such as nylon. It is also possible to use fabric or parachute cord. An end of the retractable tether can connect to the charging cable 18 via a loop that increases its grip on the cable as weight is exerted on the loop. However, other possible connecting ends of the retractable tether 28 are possible. For instance, a bent shaped plastic or metallic part can be used, matching the minimum bending radius of the cable as shown in FIG. 7. The material of the retractable tether 28 can be selected such that it will withstand exposure to weather elements and can also withstand the weight of the charging cable 18. It is also possible to implement the cable reel 26 using an electrically-assisted system using an electric motor.

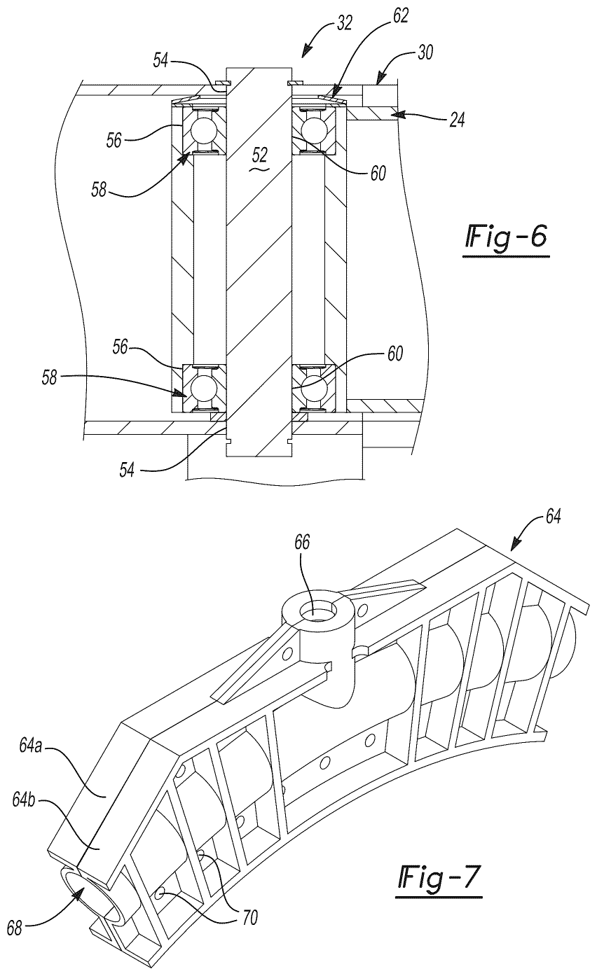

An implementation of the pivot 32 is shown in FIG. 4. The pivot 32 can include a stud 52 that passes through the elongated frame 30 as well as the movable support arm 24 and can be received by the housing 21 of the stationary vehicle battery charger 16 or by the frame 30. The movable support arm 24 and the elongated frame 30 can include apertures 54 through which the stud 52 passes. Bearing recesses 56 can be positioned within the aperture 54 of the movable support arm 24 to hold bearings 58 having inner diameters 60 that closely conform to and hold the stud 52 in a vertical position. In this implementation, the bearings 58 use a plurality of ball bearings positioned between and inner and outer race. However, other implementations are possible using plastic dry run bushings or other similar bearing/bushing designs. The bearings 58 can help minimize the amount of force exerted by a vehicle user moving the movable support arm 24 between a stowed and deployed position. A possible bearing implementation could be a thrust bearing. Or in another possible implementation, a washer could be used with a pre-load, such as a spring, as is shown in FIG. 6. This can provide friction torque to control the movement of the moveable support arm 24.

Turning to FIG. 5, another implementation of a charging cable management assembly 22′ is shown. In this implementation, the charging cable management assembly 22′ includes a first movable support arm 24a, a second movable support arm 24b, and an elongated frame 30′. The charging cable management assembly 22′ can be mounted along the front 38 of the housing 21 and attach to the stationary vehicle battery charger 16 through the housing 21. The first movable support arm 24a can couple to the elongated frame 30′ via a first pivot 32a and the second movable support arm 24b can couple to the frame 30′ via a second pivot 32b. The first movable support arm 24a can include a first cable reel 26a and the second movable support arm 24b can include a second cable reel 26a. Each cable reel 26a, 26b can include its own retractable tether 28a, 28b coupled to a charging cable 18. The charging cable management assembly 22′ can be used for stationary vehicle battery chargers 16 that include more than one charging cable 18.

FIG. 7 depicts an implementation of a cable holder 64 that can be used with a charging cable management assembly. The cable holder 64 can include an attachment point 66 configured to couple with the movable support arm 24. The cable holder 64 can include a cable receiving channel 68 that is shaped to closely conform to an outer surface of the charging cable 18. The cable holder 64 can be formed from two or more segments 64a, 64b that can be joined together around an axial length of the charging cable 18 to encapsulate the axial length of the charging cable 18 and also support the charging cable 18. The segments 64a, 64b can be joined together through a plurality of apertures 70 formed in the segments 64a, 64b that receive threaded connectors, such as bolts, and bind the segments 64a, 64b together. This can be achieved by clips or shaped segments engaging each other. While the segments 64a, 64b are joined together, they can form the cable receiving channel 68. The cable receiving channel 68 can have a cross-sectional shape that closely conforms to an outer surface of the cable channel 18. In this implementation, the cross-sectional shape is substantially circular, but other cross-sectional shapes are possible. The cable receiving channel 68 can have an arched shape that may be selected based on a maximum bending radius of the electrical cable chosen for the charging cable 18. In one implementation, the cable holder 64 can attach to the retractable tether 28a, 28b at the attachment point 66 thereby supporting the charging cable 18 as it is deployed and retracted.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A charging cable management assembly configured to couple to a stationary vehicle battery charger, comprising:
an elongated frame configured to be coupled to the stationary vehicle battery charger;
a movable support arm, coupled to the elongated frame, movable relative to the stationary vehicle battery charger and a battery electric vehicle (BEV) between a stowed and a deployed position relative; and
a cable reel, attached to the movable support arm, deploying a retractable tether, configured to couple to a charging cable of the stationary vehicle battery charger, that assists a vehicle user moving the charging cable into electrical engagement with the BEV.

2. The charging cable management assembly recited in claim 1, wherein the elongated frame extends along a side of a housing of the stationary vehicle battery charger and along a front of the stationary vehicle battery charger.

3. The charging cable management assembly recited in claim 1, wherein the elongated frame includes a plurality of sections at least two of which are joined at angle.

4. The charging cable management assembly recited in claim 1, wherein the cable reel includes a spool around which the retractable tether winds.

5. The charging cable management assembly recited in claim 1, wherein the cable reel is attached to a distal end of the movable support arm.

6. The charging cable management assembly recited in claim 1, further comprising a powered shaft attached to the elongated frame and the movable support arm to assist movement of the movable support arm between the stowed and deployed position.

7. The charging cable management assembly recited in claim 6, wherein the powered shaft is electrically powered with an electric motor.

8. A charging cable management assembly configured to couple to a stationary vehicle battery charger, comprising:
an elongated frame configured to be coupled to the stationary vehicle battery charger;
a movable support arm, connected to the elongated frame via a pivot, pivotable relative to the stationary vehicle battery charger and a battery electric vehicle (BEV) between a stowed and a deployed position; and
a cable reel, attached to the movable support arm, deploying a retractable tether, configured to couple to a charging cable of the stationary vehicle battery charger, that assists a vehicle user moving the charging cable into electrical engagement with the BEV.

9. The charging cable management assembly recited in claim 8, further comprising a bearing included with the pivot.

10. The charging cable management assembly recited in claim 9, wherein the bearing includes ball bearings.

11. The charging cable management assembly recited in claim 10, further comprising apertures in the elongated frame and the movable support arm that receive the bearing.

12. The charging cable management assembly recited in claim 8, wherein the elongated frame extends along a side of a housing of the stationary vehicle battery charger and along a front of the stationary vehicle battery charger.

13. The charging cable management assembly recited in claim 8, wherein the elongated frame includes a plurality of sections at least two of which are joined at angle.

14. The charging cable management assembly recited in claim 8, wherein the cable reel is attached to a distal end of the movable support arm.

15. The charging cable management assembly recited in claim 8, further comprising a powered shaft attached to the elongated frame and the movable support arm to assist movement of the movable support arm about the pivot between the stowed and deployed position.

16. A charging cable management assembly configured to couple to a stationary vehicle battery charger, comprising:
an elongated frame configured to be coupled to the stationary vehicle battery charger;
a first movable support arm, coupled to the elongated frame, movable relative to the stationary vehicle battery charger and a battery electric vehicle (BEV) between a stowed and a deployed position;
a first cable reel, attached to the first movable support arm, deploying a retractable tether, configured to couple to a charging cable of the stationary vehicle battery charger, that assists a vehicle user moving the charging cable into electrical engagement with the BEV;
a second movable support arm, coupled to the elongated frame, movable relative to the stationary vehicle battery charger and the BEV between the stowed and the deployed position; and
a second cable reel, attached to the second movable support arm, deploying another retractable tether, configured to couple to an additional charging cable of the stationary vehicle battery charger, that assists the vehicle user moving the additional charging cable into electrical engagement with the BEV.

17. The charging cable management assembly recited in claim 16, wherein the first movable support arm is coupled to the elongated frame about a pivot.

18. The charging cable management assembly recited in claim 16, wherein the second movable support arm is coupled to the elongated frame about another pivot.

19. The charging cable management assembly recited in claim 16, further comprising a powered shaft attached to the elongated frame and the first movable support arm to assist movement of the first movable support arm between the stowed and deployed position.

20. The charging cable management assembly recited in claim 19, further comprising another powered shaft attached to the elongated frame and the second movable support arm to assist movement of the second movable support arm between the stowed and deployed position.
